(19) United States
(12) Patent Application Publication
(10) Pub. No.: US 2010/0228995 A1
(43) Pub. Date: Sep. 9, 2010

(54) Universal Serial Bus Data Encryption Device with the Encryption Key Delivered by any Infrared Remote Handheld Controller where the Encryption Key is Unreadable by the Attached Computer System

(76) Inventors: William E. Jacobus, Woodbury, MN (US); Catherine A. Jacobus, Woodbury, MN (US)

Correspondence Address: William Eugene Jacobus, 3279 Churchill Drive, Woodbury, MN, 55125, US

(21) Appl. No.: 12/716,802

(22) Filed: Mar. 3, 2010

Related U.S. Application Data
(60) Provisional application No. 61/209,336, filed on Mar. 6, 2009.

(51) Int. Cl. G06F 21/00

(52) U.S. Cl. 713/189

(57) ABSTRACT

The user may deliver an encryption key via any infrared remote controller to a computer data encryption controller external to the computing system but connected to the aforementioned computer system via the Universal Serial Bus (USB) port. The infrared delivered key may be combined with the computer system supplied key but this key can not be read directly by the computer system. All encryption functions are done external to the computers processing system, memory system, and disk drive as to erase the possibility of rouge unwanted programs such as spyware, viruses, malware, keystroke loggers, and root-kit programs from gathering encryption-key information.

This application claims benefit of the Provisional Patent Application # 61/209,336 filed Mar. 6, 2009

### BACKGROUND OF THE INVENTION

In present day the Personal Computer (PC) system is used to store, edit, and transmit user files which many times contain sensitive information. Encryption programs are generally available to encrypt computer files. Moreover external hardware encryption engines connected to the computer via one of the external ports may also be enlisted for encryption as well. Unfortunately there are many rouge programs that may compromise the security of the PC system. These rouge programs are known as spyware, viruses, malware, keystroke loggers, and root-kit programs.

These programs target personal data to the point that the user may be unaware that all data on the system is available to outside intruders. These data intruders could also have access to encryption key information if it is stored anywhere in the PC system. Even if the key is not stored on the PC system the intruders can log keystrokes or other input devices to gather this encryption key information. With this information in hand even an encrypted file is now unsecure and readable.

One such method to hide the encryption-key information from the PC is if the user can enter the encryption-key (or at least a portion of the key) without the data traveling on the standard data transports within the PC system. One way to accomplish this is to attach an external encryption controller to the Universal Serial Bus (USB) on the PC system and allow this USB external controller to gather encryption-key information without transferring that information on the USB bus protocol to the PC system. This requires the external encryption controller to have it's own out-of-band method to gather encryption-key information.

One practical way to do this is to attach an infrared receiver on the external USB encryption device with appropriate decoding so it may gather an encryption-key or a portion of the key from an infrared controller. This may be a custom build infrared transmitter or one that is usually available in most households such as a TV, DVD, Stereo, or VCR controller. The infrared pulses are undetectable by the PC system no matter what malware programs are running yet seen the external encryption controller.

Computer files or streaming data can now be sent to the USB encryption device and encrypted without any trace of the key information or any history of that information on the PC system. The encryption key would have never found itself on any wire, bus, or storage location within the PC system thus a previous key footprint is unavailable.

### SUMMARY OF THE INVENTION

The present invention relates to an encryption controller to have the ability to gather encryption-key information from an external infrared handheld transmitter.

The user would first plug-in the external USB Encryption Controller (EC) into a PC system. This controller would then look for an encryption key from the user's infrared controller keystrokes. This information then may be used as the encryption key or combined with other encryption key information already stored on the USB controller or the PC system itself. The information entered from the infrared device would be inaccessible from the PC system because it would not be placed in any readable registers or PC readable memory locations within the USB encryption controller.

Computer data can now be transferred to the encryption controller. This data is then encrypted and stored on the USB device or sent back to the PC system.

### DESCRIPTION OF THE DRAWINGS

FIG. 1 shows the Encryption Controller (EC) plugged into a PC system's USB port. A handheld infrared remote control is then pointed at the EC. The EC will then receive the infrared pulses which contain the encryption-key from the user.

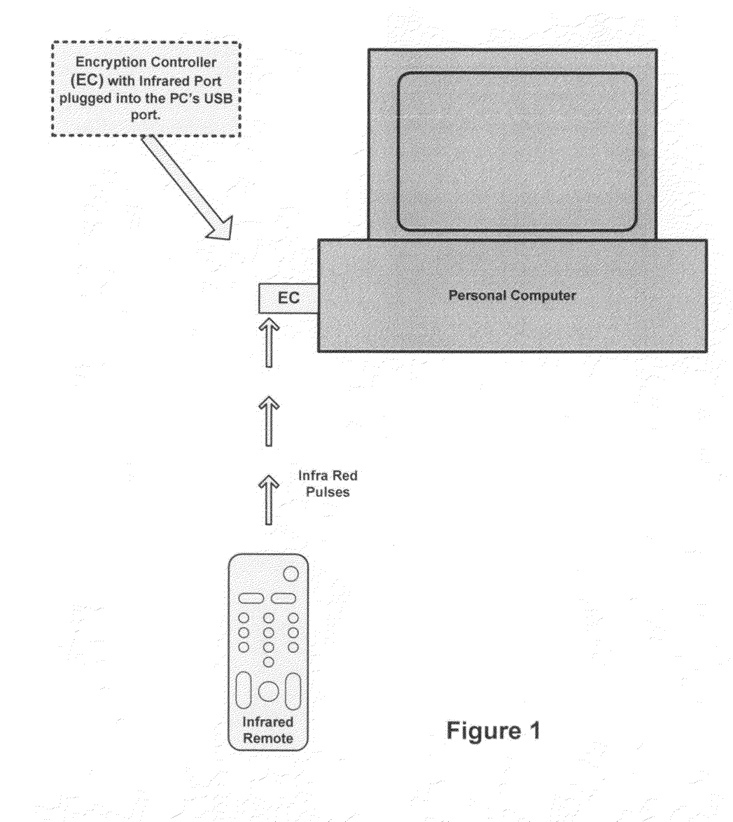

FIG. 2 details the clock diagram of the Encryption Controller. The IR photo diode received infrared encoded digits and this is passed along to the Encryption Controller Processor.

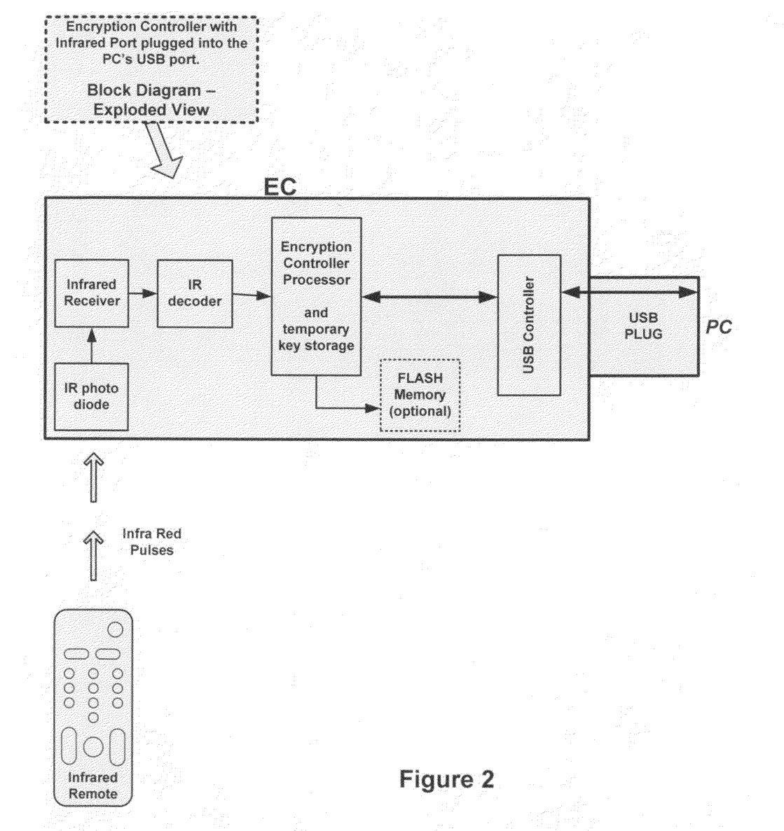

### DETAILED DESCRIPTION

The Encryption Controller (EC) is a Universal Serial Bus device that has the ability to encrypt streaming data as well as files from a PC system. The encryption key is obtained by the user keying in the encryption-key via an external infrared controller. This would bypass any standard internal or external PC bus thus not allowing a history of the encryption-key on the PC system at any time. Moreover the EC would not allow the encryption-key to be placed in any PC readable register or memory locations on the EC itself.

When the Encryption Controller USB device is plugged into the PC system it will look for a series of infrared signals from an infrared handheld controller. This controller may be a custom built controller for this function or the controller from most of the present day household handheld infrared (IR) controllers may be used. These are typically the IR units used to control the TV, DVD, Satellite Receiver, Stereo, etc. Once the user inputs this information the EC will place this data into a section of the controller that is unreadable by the PC system access of the USB port. Since the EC can only execute processor instructions local itself there is no way the PC system can gather this data from rouge code, malware, etc. The EC is a closed instruction execution processor unlike the PC system whereas outside programs are processed on the same Processor as the Operating System.

The USB encryption controller could be designed to erase this infrared key information after a predetermined time or when the USB device is disconnected from the PC. An alternate embodiment would allow the USB encryption controller to retain the infrared data if this encryption key data is used to initially prime the device with an encryption-key. This is if the user wishes to keep the encryption key information on the encryption controller permanently.

Computer files or streaming data can now be sent to the USB encryption device and encrypted without any trace of the key information or any history of that information on the PC system. The encryption key would have never found itself on any wire, bus, or storage location within the PC system thus a previous key footprint is unavailable. Computer data can now be transferred to the encryption controller. This data is then encrypted and stored on the USB device or sent back to the PC system.

I claim:

1. A method to transmit an encryption-key to a data and file encryption controller attached to the Universal Serial Bus (USB) of a computer system comprising:
Any custom built or standard Television, DVD, VCR, or Stereo handheld remote controller which is able to transmit an infrared signal via depressing a remote control button;
a remote infrared photo diode and receiver for detecting directed infrared signals;
an encryption controller which uses the infrared data as the encryption key, or partial key if combined with other encryption-key information already stored on the USB controller or the computer system itself;
an encryption controller processor which is capable of encrypting data presented to it by the computer system's Universal Serial Bus port and storing the encrypted data or writing the encrypted data back to the PC system;
an encryption controller that will not allow external programs to operate within it's own instruction code stream and not allow the encryption key to be placed in any memory location or data register that is readable by the computer system;
a USB controller able to pass computer data from the computer system's Universal Serial Port to the encryption controller.
